(19) United States
(12) Patent Application Publication
(10) Pub. No.: US 2024/0152949 A1
(43) Pub. Date: May 9, 2024

(54) Navigation Groups with Dynamic Destination Changes

(71) Applicant: Google LLC, Mountain View, CA (US)

(72) Inventors: Bruce Bahnsen, Boulder, CO (US); Yan Mayster, Aurora, CO (US)

(21) Appl. No.: 18/028,985

(22) PCT Filed: Mar. 18, 2022
(86) PCT No.: PCT/US2022/020917

§ 371 Date: Mar. 28, 2023

(51) Int. Cl. G06Q 30/0214

(52) U.S. Cl. CPC G06Q 30/0214

(57) ABSTRACT

The technology generally relates to providing information to users of a group as they plan on traveling or begin traveling to a destination. The information may be provided in a manner that balances the communication of information to users with user safety. The information may be offers, such as coupons or vouchers, to encourage or entice the users to change their destination to a point of interest associated with the offer. The information may be based on characteristics related to the initial destination, such as a classification of the initial destination. The information may be provided to the users of the group during the group's planning stage, after a destination is selected, or while the users are traveling to the destination. If one or more users of the group selects the point of interest, the destination for each of the users may be updated.

### BACKGROUND

A user may send an invite to one or more users to create a group of users for an event. The invite may include details pertaining to the event, such as the day, time, location, etc. The users may use the details within the event to reach the destination. For example, a user may refer to the event invite to determine the location of the event. The user may then enter that location into a map application to receive directions to the location. If a user of the group changes the destination, a new or updated invite is sent out to the users. The users then have to update the map application to receive directions to the updated location. This may be cumbersome, as the users will have to switch between multiple applications and input new information each time details pertaining to the event change. Moreover, the users may only change destinations based on the suggestion of another user.

### BRIEF SUMMARY

The technology generally relates to a method of providing information to users of a group as they plan on traveling or begin traveling to a destination. The group may be formed by a user sending an invite to one or more other users. The invite may include a key associated with a session ID. The session ID may be linked to an event on an event application server. Users that have the key may be provided information related to the event. As details regarding the event are changed or updated, users that have accepted the event invite and have the key may receive updates. In some examples, after the event is created, one or more points of interest related to the destination location of the event may provide information to the users. For example, the event application server or server storage may include a profile associated with each point of interest. The profile may include information, such as vouchers, offers, coupons, etc. to be transmitted to users upon a triggering event. If the event application server receives an input corresponding to a selection of the point of interest offering the information, the event information may be updated.

The event application may be associated or able to communicate with one or more applications across various platforms or operating systems. For example, the event application may communicate with mapping applications or ride sharing applications to assist with getting the users to the destination location. As the event changes, the event application server may transmit updates to the event to the associated application. For example, if the event changes due to a user selecting a point of interest in response to the information provided, the event application server may transmit updates to a mapping application or ride sharing application to update the destination location.

One aspect of the disclosure is directed to a method comprising inputting, by one or more processors, a destination location for a group of users; receiving, by the one or more processors, information from one or more points of interest related to the destination location; outputting, by the one or more process, the one or more points of interest and the information from each of the one or more points of interest; receiving, by the one or more processors, an input selecting one of the one or more points of interest; and updating, by the one or more processors for display, the destination location to the selected one of the one or more points of interest.

Receiving information from the one or more points of interest may further include identifying, by the one or more processors based on the destination location, a classification of the destination location. The method may further include determining, by the one or more processors based on the identified classification, information from the one or more points of interest having a same classification as the classification of the destination location. The classification of the destination location may include at least one of a gas station, a restaurant, a store type, a lodging type, a recreational facility, an entertainment venue, or a public space.

The information from the one or more points of interest may include a discount code, a special offer, or a voucher. According to some examples, the information from the one or more points of interest may include dynamic offer information. Receiving the input selecting the one of the one or more points of interest may further include receiving, by the one or more processors, the input from at least one user of the group of users. Receiving the input selecting the one of the one or more points of interest may further include receiving the input from each user of the group of users. The method may further include outputting, by the one or more processors, directions to the updated destination location.

The method may further include determining, by the one or more processors, whether a user of the group of users is controlling a vehicle. Outputting the information for each of the one or more points of interest may be based on determining whether the user is controlling the vehicle. Outputting the information from each of the one or more points of interest may further comprise outputting, by the one or more processors based on determining that at least one user is controlling a vehicle and at least one user is not controlling a vehicle, the information differently. Outputting the information for each of the one or more points of interests may further comprise outputting, by the one or more processors based determining that the user is controlling the vehicle, the information audibly. At least a portion of the information may not be output visually to users determined to be controlling the vehicle. Outputting the information for each of the one or more points of interests may further comprise outputting, by the one or more processors based determining that the user is not controlling the vehicle, the information visually. Outputting the information from the one or more points of interest occurs before a user of the group of users begins traveling to the destination location or after the user of the group of users begins traveling to the destination location.

Another aspect of the disclosure is directed to a device, comprising: one or more processors, the one or more processors configured to: receive an input corresponding to a destination location for a group of users; receive information from one or more points of interest related to the destination location; display the one or more points of interest and the information from each of the one or more points of interest; receive an input selecting one of the one or more points of interest; and update the destination location to the selected one of the one or more points of interest.

Receiving information from the one or more points of interest may further include identifying, by the one or more processors based on the destination location, a classification of the destination location. The one or more processors may be further configured to determine, based on the identified classification, information from the one or more points of interest having a same classification as the classification of the destination location. The classification of the destination location may include at least one of a gas station, a restaurant, a store type, a lodging type, a recreational facility, an entertainment venue, or a public space. The information from the one or more points of interest may include a discount code, a special offer, or a voucher.

When receiving the input selecting the one of the one or more points of interest the one or more processors may be further configured to receive the input from at least one user of the group of users. When receiving the input selecting the one of the one or more points of interest the one or more processors may be further configured to receive the input from each user of the group of users. The one or more processors may be further configured to output directions to the updated destination location.

The one or more processors may be further configured to determine whether a user of the group of users is controlling a vehicle. Outputting the information for each of the one or more points of interest may be based on determining whether the user is controlling the vehicle. When outputting the information from each of the one or more points of interest the one or more processors may be further configured to output, based on determining that at least one user is controlling a vehicle and at least one user is not controlling a vehicle, the information differently. When outputting the information for each of the one or more points of interests the one or more processors may be further configured to output, based on determining that the user is controlling the vehicle, the information audibly. When outputting the information for each of the one or more points of interests the one or more processors may be further configured to output, based on determining that the user is not controlling the vehicle, the information visually.

Receiving the information from the one or more points of interest may occur before a user of the group of users begins traveling to the destination location or after the user of the group of users begins traveling to the destination location.

Yet another aspect of the disclosure is directed to a non-transitory computer-readable medium storing instructions, which when executed by one or more processors, cause the one or more processors to: receive an input corresponding to a destination location for a group of users; receive information from one or more points of interest related to the destination location; display the one or more points of interest and the information from each of the one or more points of interest; receive an input selecting one of the one or more points of interest; and update the destination location to the selected one of the one or more points of interest.

Receiving information from the one or more points of interest may further include identifying, by the one or more processors based on the destination location, a classification of the destination location. The one or more processors may be further configured to determine, based on the identified classification, information from the one or more points of interest having a same classification as the classification of the destination location. The classification of the destination location may include at least one of a gas station, a restaurant, a store type, a lodging type, a recreational facility, an entertainment venue, or a public space. The information from the one or more points of interest may include a discount code, a special offer, or a voucher.

When receiving the input selecting the one of the one or more points of interest the one or more processors may be further configured to receive the input from at least one user of the group of users. When receiving the input selecting the one of the one or more points of interest the one or more processors may be further configured to receive the input from each user of the group of users. The one or more processors may be further configured to output directions to the updated destination location.

The one or more processors may be further configured to determine whether a user of the group of users is controlling a vehicle. Outputting the information for each of the one or more points of interest may be based on determining whether the user is controlling the vehicle. When outputting the information from each of the one or more points of interest the one or more processors may be further configured to output, based on determining that at least one user is controlling a vehicle and at least one user is not controlling a vehicle, the information differently. When outputting the information for each of the one or more points of interests the one or more processors may be further configured to output, based determining that the user is controlling the vehicle, the information audibly. When outputting the information for each of the one or more points of interests the one or more processors may be further configured to output, based determining that the user is not controlling the vehicle, the information visually.

Receiving the information from the one or more points of interest may occur before a user of the group of users begins traveling to the destination location or after the user of the group of users begins traveling to the destination location.

Another aspect of the disclosure is directed to a method, comprising: receiving, by one or more processors, a destination location for a group of users; determining, by the one or more processors, information from one or more points of interest related to the destination location; outputting, by the one or more processors, the one or more points of interest and the information from each of the one or more points of interest; receiving, by the one or more processors, an input selecting one of the one or more points of interest; and updating, by the one or more processors, the destination location to the selected one of the one or more points of interest.

The method may further comprise identifying, by the one or more processors based on the received destination location, a classification of the destination location. Determining information from the one or more points of interest related to the destination location may further include determining, by the one or more processors based on the identified classification, information from the one or more points of interest having a same classification as the classification of the destination location. The classification of the destination location may include at least one of a gas station, a restaurant, a store type, a lodging type, a recreational facility, an entertainment location, or a park. Information from the one or more points of interest may include a discount code, a special offer, or a voucher.

Receiving the input selecting one of the one or more points of interest may include receiving the input from at least one user of the group of users. Receiving the input selecting one of the one or more points of interest may include receiving the input from each user of the group of users.

The method may further include outputting, by the one or more processors to each user of the groups of users, directions to the updated destination location. Outputting the directions to each user of the group of users may further include outputting different directions to the updated destination location to each user of the group of users.

The method may further include determining, for each user of the group of users, whether each user is controlling a vehicle. Outputting the information from each of the one or more points of interest may be based on determining whether each user is controlling a vehicle. Outputting the information from each of the one or more points of interest may comprise outputting the information differently based on determining that at least one user is controlling a vehicle and at least one user is not controlling a vehicle. Outputting the information from each of the one or more points of interest may comprise outputting the information audibly to users determined to be controlling a vehicle. At least a portion of the information may not be output visually to users determined to be controlling a vehicle. Outputting the information from each of the one or more points of interest may further comprise outputting the information visually to users determined to not be controlling a vehicle.

Another aspect of the disclosure is directed to a method, comprising: receiving, by one or more processors, a destination location for a group of users; receiving, by the one or more processors, information corresponding to one or more points of interest related to the destination location; displaying, by the one or more processors, the information corresponding to at least one of the one or more points of interest; receiving, by the one or more processors, an input indicating a selection of a first point of interest from the at least one of the one or more points of interest; and updating, by the one or more processors, the destination location to the first point of interest.

The information from the one or more points of interest may include dynamic offer information based on the destination location. The information from the one or more points of interest may include a discount code, a special offer, or a voucher.

The method may further comprise outputting, by the one or more processors, directions to the updated destination location. Receiving information from the one or more points of interest may further include further identifying, by the one or more processors based on the destination location, a classification of the destination location. The method may further comprise determining, by the one or more processors based on the identified classification, information from the one or more points of interest having a same classification as the classification of the destination location. The classification of the destination location may include at least one of a gas station, a restaurant, a store type, a lodging type, a recreational facility, an entertainment venue, or a public space.

The method may further comprise transmitting, by the one or more processors, an invite to one or more users of the group of users. The method may further comprise transmitting, by the one or more processors, the updated destination to the first point of interest to the one or more users of the group of users.

### BRIEF DESCRIPTION OF THE DRAWINGS

FIG. 1A is a functional diagram of an example system in accordance with aspects of the disclosure.

FIG. 1B is a pictorial diagram of the example system of FIG. 1, in accordance with aspects of the disclosure.

FIG. 2 is a pictorial diagram of an example event invitation interface in accordance with aspects of the disclosure.

FIG. 3 is a pictorial diagram of an example event invitation interface in accordance with aspects of the disclosure.

FIGS. 4A and 4B are pictorial diagrams of example interfaces in accordance with aspects of the disclosure.

FIG. 5 is a pictorial diagram of an example interface in accordance with aspects of the disclosure.

FIG. 6 is a pictorial diagram of an example interface in accordance with aspects of the disclosure.

FIG. 7 is a pictorial diagram of an example interface in accordance with aspects of the disclosure.

FIG. 8 is a pictorial diagram of an example interface in accordance with aspects of the disclosure.

FIG. 9 is a flow diagram in accordance with aspects of the disclosure.

FIG. 10 is a flow diagram in accordance with aspects of the disclosure.

### DETAILED DESCRIPTION

The technology generally relates to a method for providing information related to a point of interest to users of a group as they plan on traveling or begin traveling to a destination. The information may encourage and entice users to select or change their destination to the point of interest (“POI”) associated with the information provided. For example, if one or more users of the group updates the destination to the point of interest associated with the provided information, the destination for each of the users in the group may be updated to the same destination corresponding to the location of the selected point of interest. Updating the destination may include updating navigational directions for each user to arrive at the updated destination location.

According to one example, a user may create an event invite using an event application or an application associated with the event application. The event invite may include a session ID and a related key. The key may be, for example, the event invite, a QR code, a hashtag, or a unique identifier associated with the information for the session ID. A user that receives and subsequently accepts the event invite may become part of the group. Any user that has the key associated with the session ID may be included in the group for that session ID.

The event invite may include information pertaining to an event, such as a dinner event. For example, the event invite may include the date and time of the event. In some examples, the location may be indicated in the event. Additionally or alternatively, destination preferences may be selected. The event application may use the destination preferences to suggest or identify possible POIs or destination locations. For example, the event application may query a database to identify one or more POIs that fulfill the selected destination preferences.

The event application may be associated with, or capable of, communicating with other applications across various platforms or operating systems. In some examples, the event application may communicate with calendar applications to integrate the event into the calendar. Additionally or alternatively, the event application may communicate with navigational applications or ride-sharing applications to assist the user in reaching the destination location. According to some examples, the event application may be a calendar application, the navigational application, etc.

During the event planning stage, after the destination location is set, or during travel to the destination location, users that have the key associated with the session ID may receive information corresponding to points of interest related to the destination location. For example, if the destination location was a bowling alley, a related point of interest may be an arcade. The information corresponding to the points of interest related to the destination location may include dynamic offer information based on the destination location to encourage users to change their destination to the arcade. Dynamic offer information may include pricing information. For example, a point of interest may dynamically change a discount being offered based on the destination location. In another example, the dynamic offer information may increase the discount being offered if the point of interest is a direct competitor to the original destination location. In some instances, the dynamic offer information may change as time progresses or as users of the group get closer to the point of interest. For example, as users of the group navigate close to a related point of interest, the offer may increase to encourage or provide incentive to the users to switch their destination to the point of interest. In yet another example, the information may include offers, coupons, or vouchers.

According to some examples, dynamic offer information may include bidding information. For example, the bidding information may be used by the event application to determine which information corresponds to points of interest to output to the group. The dynamic offer information corresponding to a point of interest may, as part of a point of interest profile, have parameters to define a maximum offer available. For example, a first related point of interest may increase a discount up to a maximum of twenty percent (20%) off while a second related point of interest may have a maximum discount of fifty dollars ($50) off. The event application may determine, based on the maximum offers for each of the related points of interest, which information corresponding to a related point of interest to output. In some examples, the event application may select the best, or highest, offer.

One or more users of the group of users may select a destination based on the information related to the destination provided to the users. In some examples, the destination may be updated when only a single user selects the new destination, when the group of users unanimously select the new destination, or when a majority of users select the new destination. If a new destination is selected, the event may update the destination to the selected destination. This may, in turn, update associated applications with the updated destination location. For example, if a new destination is selected, a navigational application may automatically receive the updated destination location and, therefore, automatically update the destination to assist the user in reaching the updated destination location. The updates may be sent to each user in the group.

### Example Systems

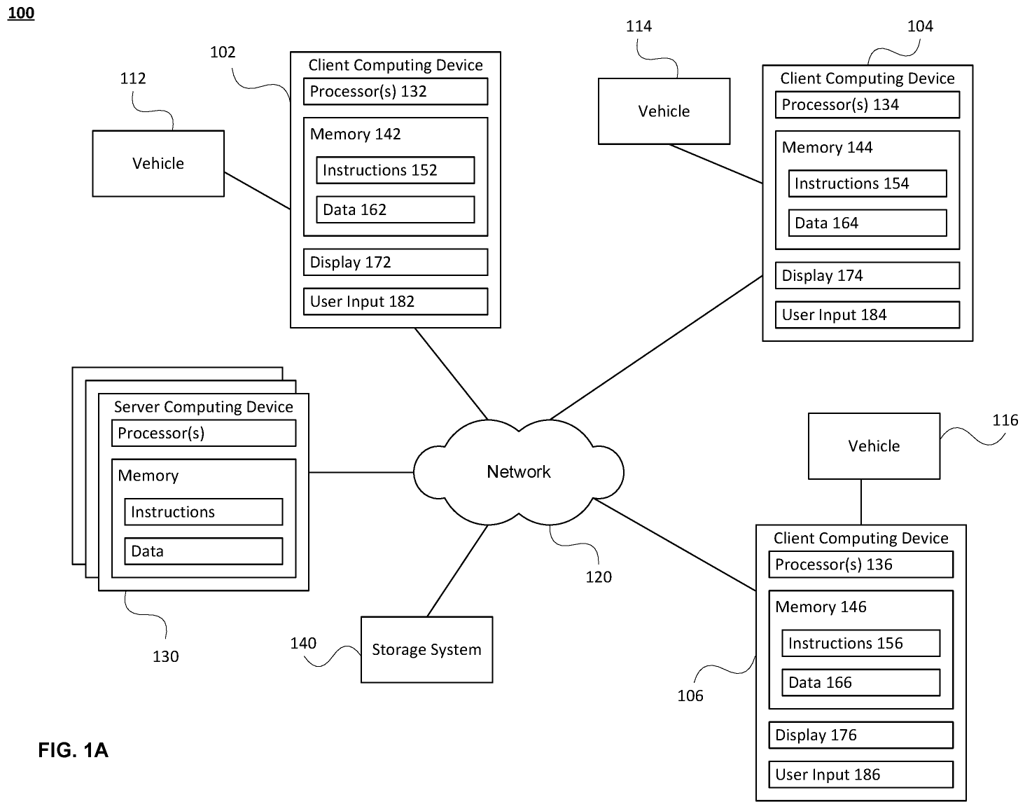

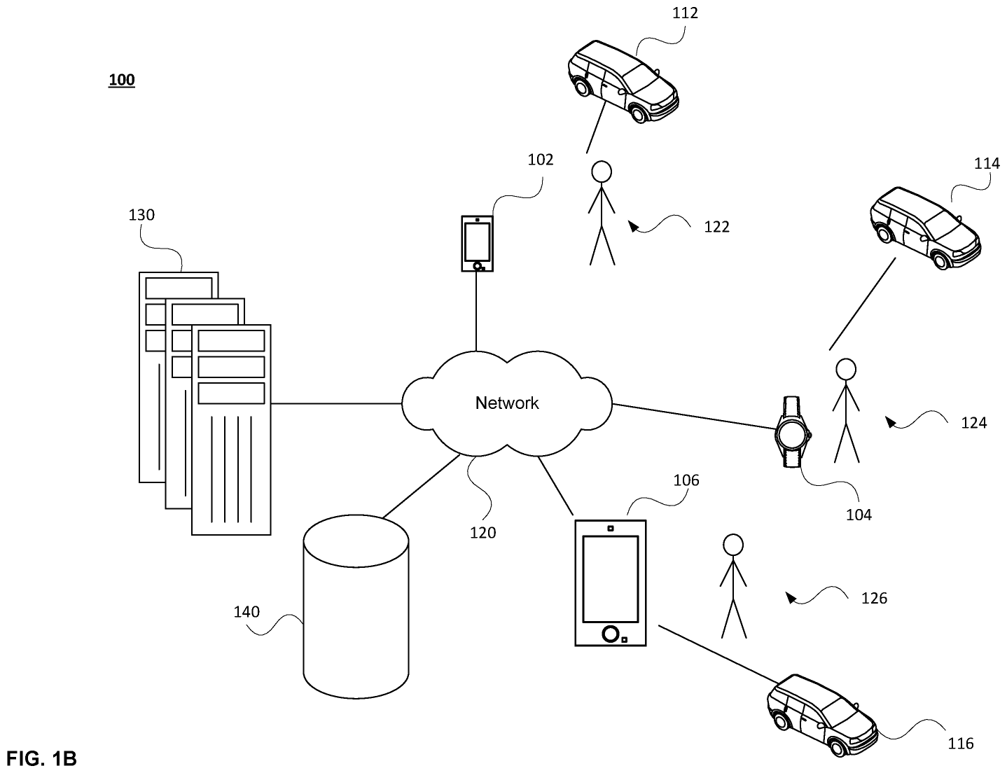

FIG. 1A illustrates an example system 100 in which the features described above may be implemented. It should not be considered limiting the scope of the disclosure or usefulness of the features described herein. In this example, system 100 may include a plurality of devices 102, 104, 106, vehicles 112, 114, and 116, server computing device 130, storage system 140, and network 120.

Each of devices 102, 104, 106 may include one or more processors 132, 134, 136, memory 142, 144, 146, data 162, 164, 166 and instructions 152, 154, 156. Each of devices 102, 104, 106 may also display 172, 174, 176 and user input 182, 184, 186.

Memory 142, 144, 146 of devices 102, 104, 106 may store information that is accessible by processor 132, 134, 136. Memory 142, 144, 146 may also include data that can be retrieved, manipulated or stored by the processor 132, 134, 136. The memory 142, 144, 146 may be of any non-transitory type capable of storing information accessible by the processor 132, 134, 136, including a non-transitory computer-readable medium, or other medium that stores data that may be read with the aid of an electronic device, such as a hard-drive, memory card, read-only memory (“ROM”), random access memory (“RAM”), optical disks, as well as other write-capable and read-only memories. Memory 142, 144, 146 may store information that is accessible by the processors 132, 134, 136, including instructions 152, 154, 156 that may be executed by processors 132, 134, 136, and data 162, 164, 166.

Data 162, 164, 166 may be retrieved, stored or modified by processors 132, 134, 136 in accordance with instructions 152, 154, 156. For instance, although the present disclosure is not limited by a particular data structure, the data 162, 164, 166 may be stored in computer registers, in a relational database as a table having a plurality of different fields and records, XML documents, or flat files. The data 162, 164, 166 may also be formatted in a computer-readable format such as, but not limited to, binary values, ASCII or Unicode. By further way of example only, the data 162, 164, 166 may comprise information sufficient to identify the relevant information, such as numbers, descriptive text, proprietary codes, pointers, references to data stored in other memories (including other network locations) or information that is used by a function to calculate the relevant data.

The instructions 152, 154, 156 can be any set of instructions to be executed directly, such as machine code, or indirectly, such as scripts, by the processor 132, 134, 136. In that regard, the terms “instructions,” “application,” “steps,” and “programs” can be used interchangeably herein. The instructions can be stored in object code format for direct processing by the processor, or in any other computing device language including scripts or collections of independent source code modules that are interpreted on demand or compiled in advance. Functions, methods and routines of the instructions are explained in more detail below.

The one or more processors 132, 134, 136 may include any conventional processors, such as a commercially available CPU or microprocessor. Alternatively, the processor can be a dedicated component such as an ASIC or other hardware-based processor. Although not necessary, computing devices 102, 104, 106 may include specialized hardware components to perform specific computing functions faster or more efficiently.

Although FIG. 1A functionally illustrates the processor, memory, and other elements of computing devices 102, 104, 106 as being within the same respective blocks, it will be understood by those of ordinary skill in the art that the processor or memory may actually include multiple processors or memories that may or may not be stored within the same physical housing. Similarly, the memory may be a hard drive or other storage media located in a housing different from that of the computing devices 102, 104, 106. Accordingly, references to a processor or computing device will be understood to include references to a collection of processors or computing devices or memories that may or may not operate in parallel.

Display 172, 174, 176 and other displays described herein may be any type of display, such as a monitor having a screen, a touch-screen, a projector, or a television. The display 172, 174, 176 of the one or more computing devices 102, 104, 106 may electronically display information to a user via a graphical user interface (“GUI”) or other types of user interfaces. For example, as will be discussed below, display 172, 174, 176 may electronically display a map interface with turn-by-turn directions between two geographic locations, corresponding road segments, and waypoints to maximize the overall probability of finding an open parking spot when searching in a predefined area surrounding the final geographic location.

The user inputs 182, 184, 186 may be a mouse, keyboard, touch-screen, microphone, or any other type of input.

The devices 102, 104, 106 can be at various nodes of a network 120 and capable of directly and indirectly communicating with other nodes of network 120. Although three (3) computing devices are depicted in FIG. 1A, it should be appreciated that a typical system can include one or more computing devices, with each computing device being at a different node of network 120. The network 120 and intervening nodes described herein can be interconnected using various protocols and systems, such that the network can be part of the Internet, World Wide Web, specific intranets, wide area networks, or local networks. The network 120 can utilize standard communications protocols, such as WiFi or Bluetooth, that are proprietary to one or more companies. Although certain advantages are obtained when information is transmitted or received as noted above, other aspects of the subject matter described herein are not limited to any particular manner of transmission.

In one example, system 100 may include one or more server computing devices having a plurality of computing devices, e.g., a load balanced server farm, that exchange information with different nodes of a network for the purpose of receiving, processing and transmitting the data to and from other computing devices. For instance, one or more server computing devices 130 may be a web server that is capable of communicating with the one or more client computing devices 102, 104, 106 via the network 120. In addition, server computing device 130 may use network 120 to transmit and present information to a user of one of the other computing devices 102, 104, 106 or a passenger of a vehicle. In this regard, vehicles 112, 114, 116 may be considered client computing devices. Server computing device 130 may include one or more processors, memory, instructions, and data. These components operate in the same or similar fashion as those described above with respect to computing devices 102, 104, 106.

As shown in FIG. 1B, each device 102, 104, 106 may be a personal computing device intended for use by a respective user 122, 124, 126, and have all of the components normally used in connection with a personal computing device including a one or more processors (e.g., a central processing unit (CPU)), memory (e.g., RAM and internal hard drives) storing data and instructions, a display (e.g., a monitor having a screen, a touch-screen, a projector, a television, or other device such as a smart watch display that is operable to display information), and user input devices (e.g., a mouse, keyboard, touchscreen or microphone). The devices may also include a camera for recording video streams, speakers, a network interface device, and all of the components used for connecting these elements to one another. Devices 102, 104, 106 may be capable of wirelessly exchanging or obtaining data over the network 120.

Although the client computing devices may each comprise a full-sized personal computing device, they may alternatively comprise mobile computing devices capable of wirelessly exchanging data with a server over a network such as the Internet. By way of example only, devices 102, 104, and 106 may be mobile phones or devices such as a wireless-enabled PDA, smartphones, a tablet PC, a wearable computing device (e.g., a smartwatch, AR/VR headset, smart helmet, etc.), or a netbook that is capable of obtaining information via the Internet or other networks.

Users 122, 124, 124 may operate a respective vehicle 112, 114, 116 in using the system to find parking for said vehicle 112, 114, 116. Vehicles 112, 114, 116 may include a computing device (not shown). The computing device may include one or more components similar to devices 102, 104, 106, such as one or more processors, memory, data, instructions, a display, a user input, etc. According to some examples, vehicles 112, 114, 116 may include a perception system for detecting and performing analysis on objects external to the vehicle such as other vehicles, obstacles in the roadway, traffic signals, signs, trees, etc. Additionally or alternatively, the perception system may determine whether the vehicle is in motion or parked. For example, the perception system may include lasers, sonar, radar, one or more cameras, or any other detection devices which record data which may be processed by a computing device (not shown) within vehicles 112, 114, 116. In the case where the vehicle is a small passenger vehicle such as a car, the car may include a laser mounted on the roof or other convenient locations as well as other sensors such as cameras, radars, sonars, and additional lasers (not shown).

Storage system 140 may store various types of information. For instance, the storage system 140 may store data or information related to POIs for retrieval in response to the creation of an event. As used herein, POIs may include any location, or destination, that a user can visit, such as a park, green space, restaurant, theater venue, amusement park, shopping center, etc. The POI information may be stored as a POI profile. The POI profile may be stored on storage system 140. The POI profile may include, for example, contact information, hours of operation, ratings, etc. associated with the POI.

According to some examples, the POI profile may, additionally or alternatively, include information to be sent to users based on characteristics related to an initial destination for an event. The information may be sent to users during the initial planning of an event, after a destination for the event is selected, or when users are traveling to the event destination. The information may include offers, vouchers, or coupons to encourage or entice users to change their event destination to the POI associated with the offer.

The POI profile may, additionally or alternatively, include parameters as to how many offers, vouchers, coupons, etc., may be sent to users in a predetermined time period. Additional parameters may include when to send the offers, vouchers, or coupons to users. In some examples, the POI profile includes parameters defining dynamic offer information, such as a first type of offer, voucher, coupon to one group of users and a second type of offer, voucher, coupon to a second group of users. For example, the POI profile may include parameters defining an offer for a greater discount to users that are traveling a further distance than users that are nearby. In some examples, the discounts, or pricing, offered to a group of users may change over a period of time. For example, the POI profile may include parameters defining dynamic changes to an offer based on the intended destination location, number of users in the group, how close the users are to the POI, etc. According to some examples, the POI profile may include parameters defining dynamic offer information such that the information includes a greater offer when the original location is a direct component, increasing offers as users of the group approach the POI, etc. Additionally or alternatively, the POI profile may include parameters defining an offer for competitive pricing, such as price matching or beating a competitor's pricing by a certain percentage.

Storage system 140 may store map data. This map data may include, for instance, locations of POIs, locations of driving lanes, parking lanes, designated parking areas, no parking zones, drop off locations, etc. Map data may also include locations, road names, road configurations, etc.

### Example Methods

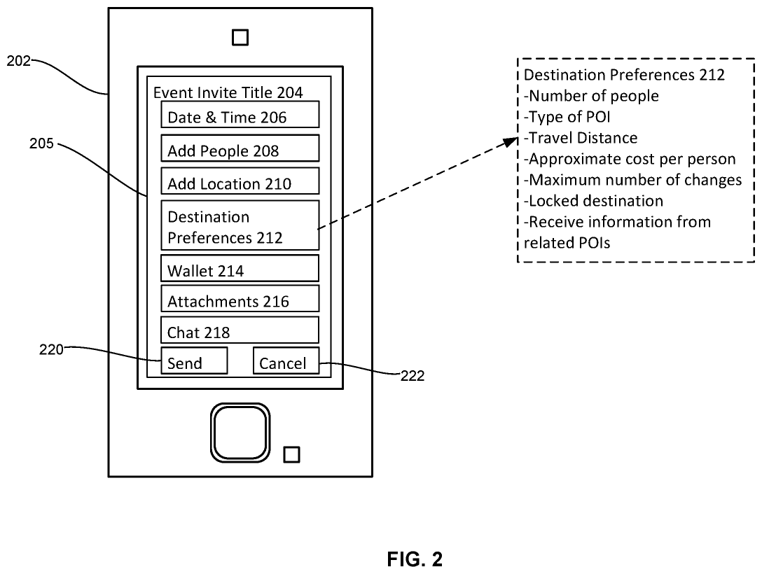

FIG. 2 illustrates an example user interface for creating an event. For example, an event application may be used to create and send event invite 204. The event invite 204 be used to form a group of users. According to some examples, the group of users may be formed by sending an invite via message, a QR code, a calendar invite, etc. For each group of users, a unique session identification (“session ID”) identifying the group may be generated. The invite may be sent to the additional users via text, e-mail, QR code, calendar invite, etc. According to some examples, any application associated or in communication with the event application server may be used to create and send an event invite 204. For example, a calendar application in communication with the event application server may be used to create and send event invite 204. In some examples, event invite 204 may be created and sent from a social media application, mapping application, messaging application, etc.

Event invite 204 may include a key that associates event invite 204 with a session ID. In this regard, the key may be linked to the session ID. The session ID or key may be created by the event application and associated with the event invite 204. In some examples, the session ID may be associated with or created by an event application that can communicate with other applications across various platforms or operating systems. For example, the event application may be able to communicate with navigational applications (e.g., mapping programs), ride-share applications, search engines, point of interest profiles, etc. across various platforms or operating systems.

The event invite 204 may include additional information relating to plans being made amongst users. For example, the event may include a location, a start time, a duration, participant information, roles for each participant, payment information, cloud based storage, etc. According to some examples, the additional information may be shared with each user that is given the key associated with the session ID for the event.

The key may be what is sent as a notification to other users via event invite 204. By linking the key with the session ID, information pertaining to event changes may be monitored and provided, as needed, to each user having the event invite 204 with the key.

In some examples, device 202 may output a user interface associated with an application, such as an event application, calendar application, mapping service, social media application, etc. The application may be used to create an event invite 204. Information relating to the event may be input into the event invite interface 205. Event interface 205 includes data entry fields for the date and time 206 of the event, the people 208 invited to the event, the location 210 of the event, or destination preferences 212. The event invite interface 205 may, additionally or alternatively, include the option to connect a digital wallet 214 to the event, the option to include attachments 216, or a chat box 218. According to some examples, in response to one or more options within event invite interface 205 being selected, a pop-up screen may appear. Additionally or alternatively, there may be a drop down menu providing options for the user to select, check boxes that may allow the user to select more than one option, radio buttons, text boxes for the user to enter information, etc.

According to some examples, the event invite, which may be identified based on event invite 204, may be created in a calendar application associated with the event application. The calendar application may send, or transmit, the event invite 204 to each of the additional users input into add people data entry field 208. As users 208 are added to event invite 204, the event application may notify the event tracking system of a new user associated with the event. According to some examples, the event application may assign a session ID for the new event after launching event interface 205. In some examples, the event application may assign a session ID for the new event after the event invite 204 is sent to the people 208 added to the event invite 204. As discussed above and herein, the event invite 204 may include a key associated with the session ID. For example, the event ID may be generated by the event application and/or by an application associated with the event application server. The event ID may be encoder and/or represented as a key, such as a QR code, hash, etc. The key may be sent to users as part of the event invite 204.

When or if the event invite 204 is accepted by additional users, the event application may associate the additional users with the session ID created by the event application. According to some examples, the event application may include or maintain a list of users that are associated with the session ID. For example, users that accept event invite 204 may be associated with the session ID and, therefore, are part of the group while users that decline event invite 204 may not be associated with the session ID and, therefore, are not part of the group.

For example, an event application server may host the event application. The event application server may maintain the information related to each event. The information related to the event may be, for example, the title of the event, the date and time of the event, the location of the event, destination preferences associated with the event, a digital wallet associated with the event, attachments, chats, etc. Additionally or alternatively, the event application server may enable different applications, such as the calendar application, to have access to the event information for the event though one or more asynchronous changes that may happen. For example, if one or more users select a POI associated with information provided to them, the applications may be updated with the new destination location corresponding to the selected POI.

In some examples, a user may select the destination location by entering a destination location into location data entry field 210 for the group of users. The user may be the user creating the event or event invite 204. In some examples, the user may enter one or more destination preferences into destination preferences data entry field 212. The selected, or entered, destination preferences may be used to suggest or identify candidate POIs for the event. In some examples, the destination preferences indicated in event invite 204 may be used to identify related or corresponding POIs to the selected destination. For example, the user may input or select a number of destination preferences into destination preferences data entry field 212. The destination preferences may include a number of people being invited to the event, the type of POI, a maximum or minimum travel distance to the destination, an approximate average cost per person to go to the POI, the maximum number of times the destination may change, whether the destination POI should be locked, the option to receive information from alternative POIs, etc.

Based on the entered destination preferences, the event application may suggest one or more POIs for the event. For example, the event application may query the event application server for one or more POIs that match or substantially match the destination preferences. Additionally or alternatively, if a destination was selected prior to entering destination preferences, the event application may suggest an alternative POI. In some examples, the destination preferences may be used to identify related POIs that have an offer, coupon, or voucher to be sent to the user in an effort to encourage the user to switch their selected destination to the POI providing the offer.

According to some examples, the destination location 210 may not be chosen until after the event invite 204 is sent. For example, the location to be entered into location data entry field 210 may be selected by the group of users that have accepted the event invite 204. In some examples, the group of users may add or remove destination preferences. Based on the destination preferences, the event application may suggest or identify candidate POIs that match or substantially match the user preferences. The users may select a destination location 210 from the suggested POIs. The selected destination may be received by the event application server as the input corresponding for location data entry field 210. For example, the event application server may receive destination preferences input by the one or more users into destination preferences data entry field 212 for a lunch location, such as seating for three people and the average cost per person is under $25 per person. The event application server may query various applications to provide suggestions for the group to select from. In some examples, the event application server may allow for the suggestions to be filtered, such as by distance, classification of the point of interest, etc. The event application server may provide a means for the users to come to a consensus. For example, the event application server may provide a group chat 218 for message, audio or video call capabilities, a poll for voting on an intended destination, etc. In some examples, the event application server may configure the settings for the event application such that the creator of the group may select a destination unilaterally.

According to some examples, the users may input an intended destination. The intended destination may be received by the event application server as the input corresponding to input for location data entry field 210. Additionally, or alternatively, the event application may query associated applications for destination suggestions based on destination preferences to present to the group of users.

Once a destination is selected, the event application server may update the event to include the location, address, coordinates, geo-location, etc., of the destination. This information may be used by a navigation application to assist users of the group reach the destination. In some examples, the navigation application may be a mapping application, a ride-share application, self-driving application, etc.

Event invite 204 may include an option to connect a digital wallet to the event. For example, event invite interface 205 may include a wallet data entry field 214 to enter information related to a digital wallet. The digital wallet may be used to transfer or receive funds associated with the costs for the event. For example, if the event was to go to a concert, the group of users for the event may use the digital wallet to transfer money to the user responsible for buying the tickets for the concert.

Event invite 204 may include an option to include attachments via attachments data entry field 216. The attachments may include documents, photos, videos, digital media, etc. For example, if the user selected a restaurant, the user may include a digital copy of the menu as an attachment. In some examples, where the event is a concert, the attachments 216 may include a digital copy of the tickets. Additionally or alternatively, users of the group may include attach photos, videos, gifs, etc. taken during the event.

Even invite 204 may include a chat data entry field 218. The chat data entry field 218 may allow users of the group to talk to one another within the event invite 204. For example, the users of the group may use the chat to discuss what destination location to select, whether to send money via virtual wallet, discuss attachments, etc.

In some examples, event invite 204 may include an option to send 220 or cancel 222 event invite 204. When event application receives an input corresponding to send 220, event invite 204 may be transmitted to the users 208 added to event invite 204. When event application receives an input corresponding to cancel 220, event application or event application server may discard the information entered into event invite 204.

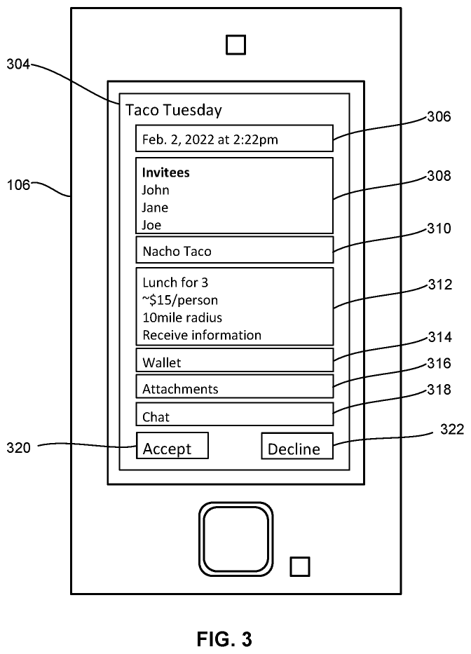

FIG. 3 illustrates an example user interface showing a received event invite 304. The event invite 304 may be for Taco Tuesday. The event invite 304 may indicate the date and time 306 of the event. For example, Taco Tuesday may start at 2:22 pm on Feb. 2, 2022. The event invite 204 may additionally include a list of invitees 308, or users that were invited to join the group. Event invite 304 may include the name, or location 310, of the selected destination. For example, the location 310 of the event may be Nacho Taco. The event invite 310 may show the destination preferences 312, such as the number of people the event is for, the average cost per person, the maximum distance from any one of the users in the group, and the option to receive information from related POIs during the planning stage and while driving to the destination.

The event invite 304 may include a key that associates event invite 304 with the session ID. According to some examples, the key may be embedded in the event invite 304. Additionally or alternatively, the event invite 304 may be the key. For example, the event invite 304 may be the tangible user-end representation of the information associated with the event and, therefore, the session ID. If a user accepts 320 the event invite 304, information pertaining to event changes may be monitored and provided, as needed, to each user having event invite 304. Event changes may be monitored, for example, by event application server. In examples where event changes occur, event changes detected or determined by event application server may be pushed to each user that has accepted 320 event invite 304. If users decline 322 event invite 304, event application server may not send any updates to those users.

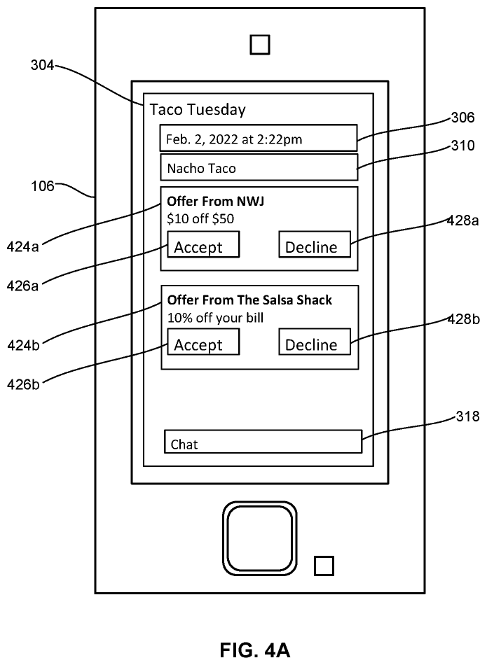

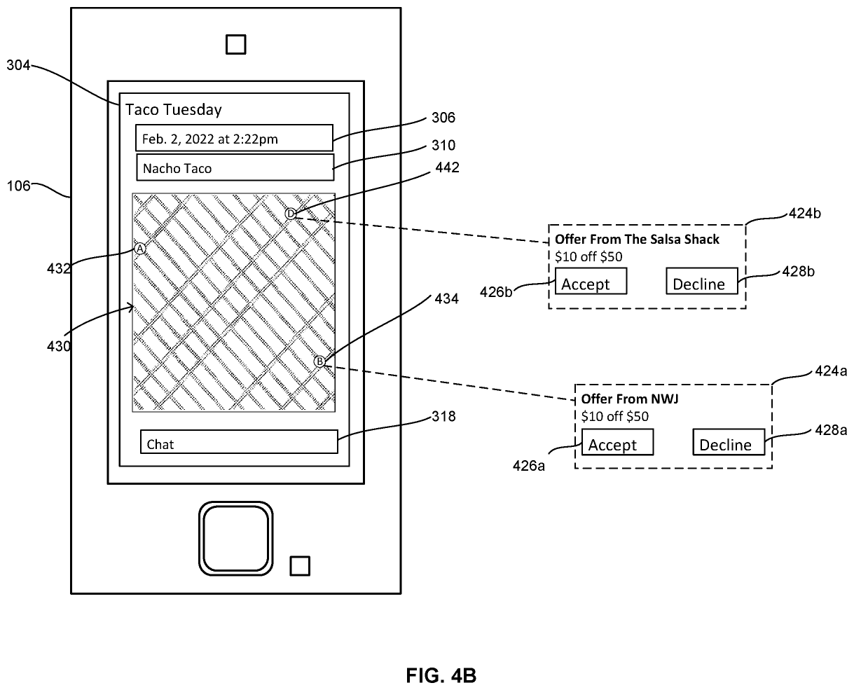

FIGS. 4A and 4B illustrate an example user interfaces for showing information pertaining to POIs different from the selected location 310. For example, after destination 310 is selected, the event application server may provide information 424 to the users via the event application for one or more POIs other than the selected destination. The POIs may be related to the selected destination 310. Related points of interest may be identified based on a classification of the point of interest being the same as a classification as the destination location 310. For example, if the destination location 310 is a bowling alley the destination location may be classified as a recreational location. In some examples, related points of interest may be other recreational locations, such as a movie theater, trampoline park, amusement park, etc. In another example, if the destination location 310 is an Italian restaurant, the destination location 310 may be classified as a restaurant. In such an example, related POIs may be other restaurants, other Italian restaurants, a food truck, etc.

The information 324 may be offers, such as coupons or vouchers, to encourage users to change their destination location 310 to the POI providing the offer. According to some examples, the information 324 to be provided to users may be within the profile associated with the POI. For example, the POI profile may indicate various information, offers, vouchers, etc., to be presented to users.

According to some examples, one or more servers associated with the event application may have a server storage system that stores profiles associated with the POIs. For example, the event application server storage system may store information related to that POI, such as their business name, hours, location, phone number, etc. The information related to the POI may be stored as a profile associated with that POI. In some examples, the event application server may create an event associated with a promotion, voucher, etc. for the POI that can be shared by the event application. For example, the event application server may provide an interface to output received information associated with the POIs.

In some examples, the information 324 may be presented to users automatically based on certain triggering actions. A triggering action may occur when a classification for the POI has the same or similar classification as the selected destination location 310. Server 130 or storage system 140 may store one or more classifications for each POI. In some examples, the classifications may be stored with or as part of the profile for the POI. The classifications may include restaurant, event venue, amusement park, public space, park, shopping center, etc. The classification may include sub-classifications. For example, if the classification is an event venue, a sub-classification may be a stadium, concert venue, theater, outdoor venue, etc. In some examples, if the classification is a restaurant, the sub-classifications may include formal dining, fast-food, take-out, café, coffee shop, bar, pub, etc. In some examples, if the classification is a restaurant, the sub-classifications may, additionally or alternatively, include a type of cuisine, such as Italian, Mexican, Chinese, brunch, breakfast, dinner, lunch, tapas, dessert, etc. Accordingly, if the selected destination is a Mexican restaurant, POIs that are classified as a “restaurant” or “Mexican food” may have information presented to the users.

In some examples, a triggering action may occur when the criteria used to suggest the destination location 310 matches criteria associated with the POI. For example, when creating the event, the users may have searched for a painting lesson for five people. The event application may have returned a number of suggested locations that provide painting lessons and have availability for five people. The event application server may present information to the users pertaining to the non-selected locations after receiving an input corresponding to an intended destination.

In some examples, the information from the POI, such as a promotion or voucher, may have a unique key or session ID that can be sent to users. The information may be received as a notification from the POI. The information may be in the form of an event invite, similar to the event invite 304 described above and herein. For example, the information may be a separate public event with a public session ID that users may elect to enroll in. In examples where a user enrolls in the public event for the POI, the event application server may create a private event associated with the public event. The private event may have a unique key or session ID specific to that user that associates the user with the event created by the POI. The unique key or session ID may include the information related to the promotion, the event location, and other event related details.

According to some examples, the event invite from the POI may be accessed by scanning a QR code. The QR code may, for example, provide access to the session ID or key to the event, information, promotion or voucher. For example, the event application server may push, or transmit, a QR code to the device of a user based on their geo-location. In some examples, the event application server may transmit the session ID or key via an application or website associated with the point of interest, etc.

As shown in FIG. 4A, event application server may transmit information 424a, 424b from POIs related to destination 310. For example, as destination location 310 was “Nacho Taco” event application server may identify related POIs. In this example, related POIs may include places that serve tacos, Mexican restaurants, restaurants open for a late lunch, etc. Related POIs may be determined based on the destination 310 or destination preferences 312. Additionally or alternatively, event application server may identify related POIs that have information available to transmit to the user. In this example, event application server identified “NWJ” and “The Salsa Shack” as a related POI that has information 424a, 424b to transmit to the group. Information 424a may include an offer or voucher, such as $10 off $50, from NWJ and information 424b may include an offer or voucher, such as 10% off your bill, from The Salsa Shack. The information 424a, 424b may be sent to one or more users of the group.

As shown in FIG. 4A, information 424a, 424b may be presented to the users as a list. In some examples, information 424a, 424b may be a pop-up that is displayed over event invite 304. In some examples, information 424a, 424b may be a notification on the display of device 102. The notification may be displayed with or without the event invite 304 being opened.

As shown in FIG. 4B, information 424a, 424b may be presented to the users within mapping application 430. For example, mapping application 430 may display a map indicating the current location 432 of the user and the locations 442, 434 of related POIs. For example, location “D” 442 may be the location of The Salsa Shack while location “B” 434 may be the location of NWJ. In response to a user input, such as a selection of location “D” 442 or location “B” 434, information 424b, 424a, respectively, may be presented to the user.

The event application server may receive an input corresponding to a selection by one or more users selecting the POI based on the information provided by the event application server related to the POI. For example, the event application server may receive an input corresponding to a user selecting accept 426. In some examples, the event application server may receive an input corresponding to a user selecting decline 428. The event application server may not update event invite 304 unless a majority of users of the group select accept 426. In some examples, the event application server may update event invite 304 if the group votes to change the destination. For example, if one user of the group is interested in changing the destination, the group may vote on whether to change the destination. The group may discuss or determine whether to change the destination location by utilizing the chat 318 in event invite 304, in the event application or an application associated with the event.

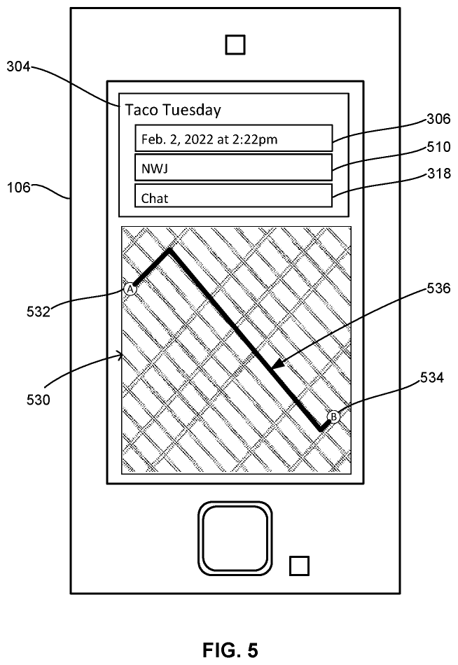

FIG. 5 illustrates an example user interface for directing users to the destination 310. One or more of the users may have accepted the information 434 from NWJ such that destination 310 has been updated to destination location 510. Thus, event invite 304 may have updated to indicate the updated destination location 510.

The key associated with the session ID may be used to query an application for the current, or updated, destination location 510. For example, applications other than the calendar application with the event invite 304 may be used to direct users to the updated destination 510. In some examples, navigational applications 530 may provide directions to assist the users in arriving to updated destination location 510. The navigational applications 530 may use the key to query the application to identify the current, or updated, destination location 510. If the destination location 510 associated with the session ID changes prior to or enroute, a new updated destination may be provided to the navigational application that has the key associated with the session ID.

As shown, a navigational application 530 associated with the event application may use the key associated with the session ID of event invite 304 to assist the user in arriving to destination 510. The navigation application 530 may show a current location 532 of the user and the intended destination 534 on the map. The navigational application 530 may indicate a possible route 536 for the user to travel to arrive at the destination.

In examples where the application is a rideshare application, the ride share application may show the current location 523 of the user, the intended destination 534, the location of one or more available rides, or a possible route 536 to reach the intended destination 534 from the current location 524. In some examples, the ride share application may, additionally or alternatively, display the estimated cost, wait time, etc. According to some examples, the intended destination 534 may be determined based on the association of the ride-share application with the event application. For example, the ride share application may use or have access to the key associated with the session ID of event invite 304. By using or having access to the key, the ride share application may use the key to query the event application or event application server for the most up to date destination location 510. According to some examples, the ride share application may automatically use location 510 as the destination for the ride share application. In some examples, the user may manually input the destination location 510.

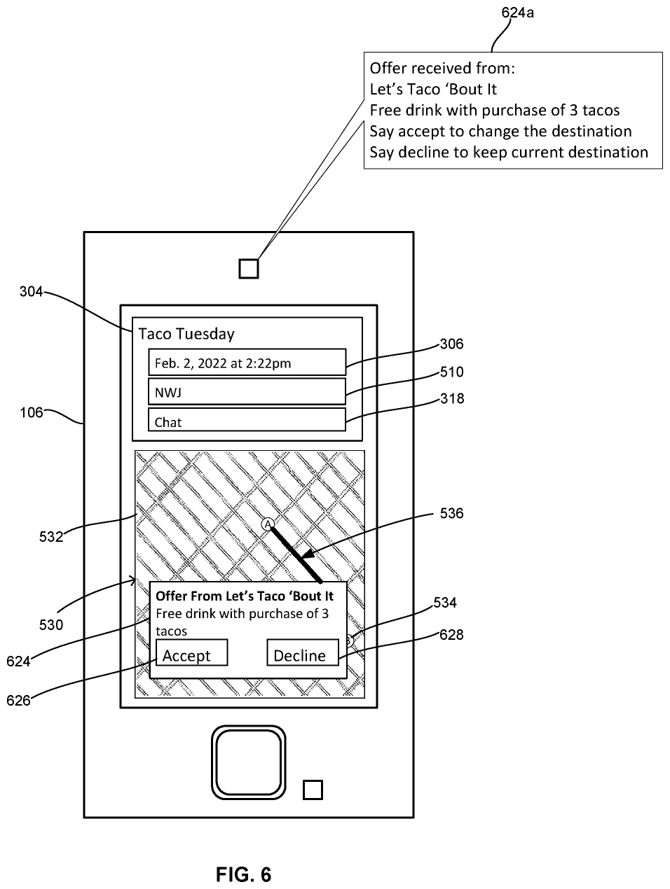

FIG. 6 illustrates an example user interface showing information pertaining to related POIs different than location 510. For example, as location 510 was “NWJ” even application server may identify related POIs that have information to be transmitted to the group of users. In this example, event application server identified “Let's Taco 'Bout It” as a related POI that has information 634 to present to the group. The information 624, 624a may be presented to one or more users of the group after the users begin traveling to destination 510. The information 624, 624a may be presented to the users based on one or more specific user conditions. The user conditions may include whether the user is a passenger in a car such that the user is not in control of the vehicle, whether the user is utilizing a ride sharing app, whether the user is in control of the vehicle, whether the user is utilizing public transportation, etc. Depending on the user condition the information 624, 624a may be presented differently such that the information 624, 624a may only be broadcast to the users that can safely make a decision.

Determination of one or more user conditions for each user of the group may be achieved in various ways. For example, it may be determined that a user operating or otherwise interacting with a ride sharing application is not controlling a vehicle, and as such any communication regarding alternative destination locations may be communicated to such a user visually, audibly or both. As another example, it may be determined that a user operating a navigation application for driving directions, or traveling at a speed indicative of driving a vehicle, is controlling a vehicle. Such a user may therefore only receive communications regarding alternative destination locations audibly to minimize user distraction while driving. The examples provided herein are merely presented to provide exemplary scenarios and, therefore, are not intended to be limiting as various methods may be used to determine whether a user is in control of a vehicle.

For a user that is not in control of the vehicle, a user that is utilizing public transportation, or for a user that is utilizing a ride sharing application, the information 624 may be presented at least visually on the display of device 102 or on the display of the vehicle.

For a user that is in control of the vehicle, the information 624a may be presented to the user audibly, such as via a voice prompt. By providing the information audibly, the users may listen to the information from the point of interest rather than be distracted by their device or have to shift their gaze away from the road while driving. As such, any user in control of a vehicle is able to control the vehicle more safely as information regarding alternative destination locations or a change of destination location may be provided audibly, minimizing user distraction. For example, all or at least a portion of information relating to points of interest may not be communicated to users in control of a vehicle at all, and instead only information relating to a change of destination location may be communicated. The change of destination location may be communicated audibly or visually, via a navigation application for example.

Information 624, 624a regarding alternative destination locations, such as POIs, may, therefore, be communicated to individual users of a group in a way that balances communication of the information with user safety. By doing so, safe and clear communication regarding the destination location is achieved. If a point of interest is selected, the event application server may update the destination to the selected point of interest. The event application server may update the event to include the updated destination. The event application server may automatically update the destination in the navigation application, ride sharing application, etc. being used by the users to reach the intended destination.

The event application server may receive an input corresponding to a selection by one or more users accepting 626 or declining 628 the POI based on the information 624 provided. While FIG. 6 illustrates a manual selection to accept 626 or decline 628 the information 624, or offer, from Let's Taco 'Bout It, the user may additionally or alternatively provide a verbal selection to accept or decline the offer.

In examples where a user from the group selects a POI based on the information from the POI, the option to update the destination may be presented to each of the users from the group. The destination may be updated to the selected POI t if at least one user accepts the change, if a majority of the users accept the change, etc. In some examples, the destination may be updated upon at least one user selecting the POI. After the POI is selected, the destination location may be updated. The users may receive updated directions to the point of interest. In another example, the option to update the destination may be presented only to users from the group which are determined to not be in control of a vehicle, avoiding distracting users determined to be controlling a vehicle.

According to some examples, the event application server may lock in the destination location 510 once at least one of the users begins to travel to the destination location. For example, a navigation application may use event information to provide directions to the destination location 510. The event application may determine that the user began traveling to the destination location 510 based on the navigation application using the event information. The event application server may receive information indicating that the user has begun navigation to destination location 510 and, therefore, may lock destination 510 in place. In such an example, if the user began traveling from their current position 532, the information 624, 624a from Let's Taco 'Bout It may not be presented to the user.

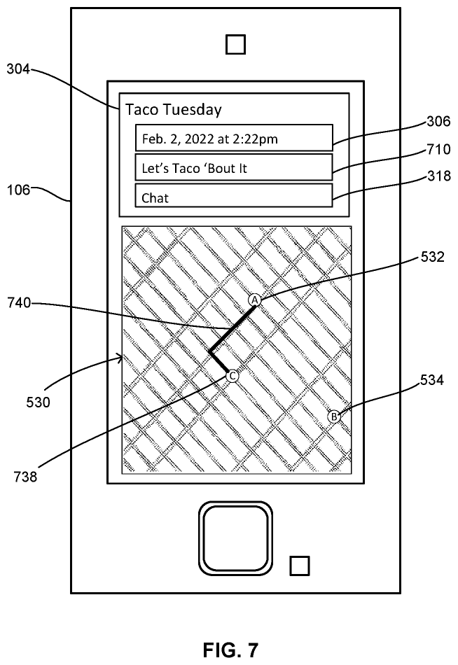

FIG. 7 illustrates an example user interface in which a navigation application is using information from event invite 304 to assist the user in reaching destination 710. For example, one or more of the users may have accepted the information 634 from Let's Taco 'Bout It such that destination location 510 has been updated to location 710.

In this example, location 510 may have been updated to location 710 while at least one of the users of the group was enroute to the destination. The key associated with the session ID and event invite 304 may be used to query an application for the updated location 710. For example, if a navigation application was being used by the user to assist in reaching the destination, the navigation application may use the key to query the event application for the updated location 710. The updated location may be, for example, the address or coordinates corresponding to Let's Taco 'Bout It. The navigation application may automatically update the directions to assist the user in reaching the updated location 710. In some examples, where a user of the group is using a rideshare application to reach the destination location, the ride share application may use the key to query the event application for the updated location 710. In such an example, the ride share application may update the directions such that the ride share driver will go to the updated location 710.

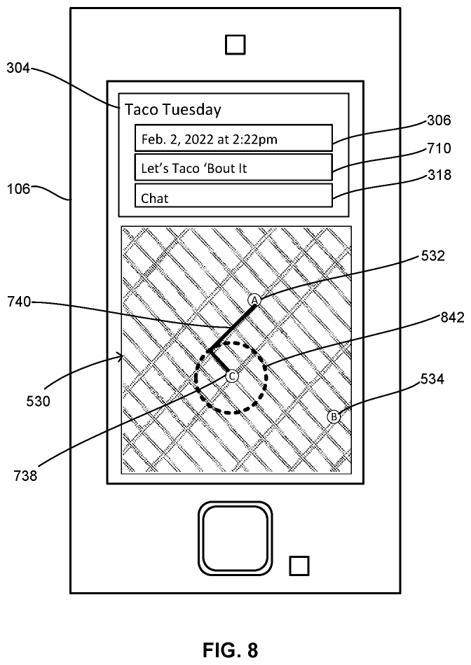

FIG. 8 illustrates an example user interface indicating a minimum distance from the destination location that a user can reach before the event application server stops transmitting information for related POIs. For example, the destination location 710 may be updated until at least one user of the group of users is within a predetermined distance 842 from the destination location 710. For example, one or more of the users may set a minimum distance 842 from the destination location 710 as one of the destination preferences. As shown in FIG. 8, the minimum distance 842 may be a radius with destination location 710, location “C” 738 on the map, as the center. If one or more users of the group reaches that minimum distance from the destination location, the destination may be locked in such that event application may stop outputting information from the points of interest to the users. Beneficially, this avoids last minute changes of destination location for users determined to be controlling a vehicle, improving user safety. According to the example shown in FIG. 8, if the user at location “A” 532 reaches the minimum distance 842, event application may stop transmitting information for POIs related to destination location 710. Additionally or alternatively, if another user of the group of users reaches the minimum distance 842 before the user at location “A” 532, the event application may stop transmitting information for POIs related to destination location 710.

According to some examples, the destination may be updated up to a predetermined number of times. For example, the event may set the maximum number of times the destination may be changed before the destination is locked in. The maximum number of changes may be chosen by a user of the group or may be predetermined by the event application. Once the maximum number of changes occurs, the event application may stop outputting information from the points of interest to the users.

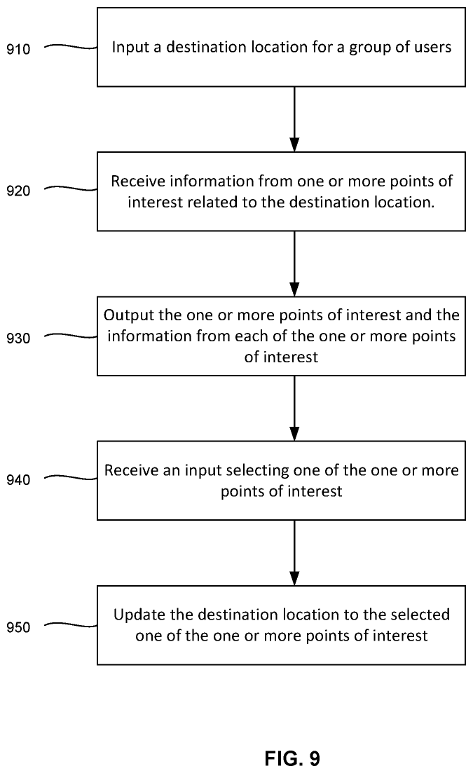

FIG. 9 illustrates an example method for updating the destination location for one or more users of the group of users. The following operations do not have to be performed in the precise order described below. Rather, various operations can be handled in a different order or simultaneously, and operations may be added or omitted.

In block 910, a device may receive an input for a destination location for a group of users. For example, a user may input the destination location into an event invite. The event invite may be transmitted to one or more users. The users that accept the invite may be the users in the group of users. The event invite may include a key associated with a session ID. For example, an event application may associate a given event with the session ID. The users that have the key associated with the session ID may receive information or updated information pertaining to the event.

In block 920, the device may receive information from one or more points of interest related to the destination location. For example, the destination location may be associated with classification, such as a restaurant, store type, lodging type, gas station, recreational facility, entertainment venue, public space, etc. The points of interest related to the destination location may have the same classification as the destination location. In some examples, the points of interest related to the destination location may be based on destination preferences input into the event invite. For example, the destination preferences may include a number of users, a maximum distance, a destination type such as restaurant, recreation facility, etc., an average cost per user, etc. Points of interest that match or substantially match the destination preferences may be related to the destination location.

The information may be, for example, a discount code, a special offer, a voucher, etc. The information may be used to encourage or entice the group of users to change the destination location to the point of interest.

In block 930, the device may output the one or more points of interest and the information from each of the one or more points of interest. In some examples, the device may display the points of interest and corresponding information as a list, on a map, as a pop-up, as a notification, etc.

According to some examples, the output of the one or more points of interest and the information may be based on a determination of whether a user of the group of users is controlling a vehicle. For example, the information may be output differently based on whether at least one user is controlling the vehicle and at least one user is not controlling the vehicle. In examples where it is determined that the user is controlling the vehicle, the information may be output audibly. In some examples, at least a portion of the information may not be output visually to users determined to be controlling the vehicle. According to some examples, when it is determined that the user is not controlling the vehicle, the information may be output visually.

In block 940, the device may receive an input selecting one of the one or more points of interest. The input may be a touch input or a verbal input. In some examples, the input may be received by one or more users of the group. For example, each user of the group may provide an input to accept the information from the point of interest before the event will update the destination location to the selected point of interest.

In block 950, the device may update the destination location to the selected one of the one or more points of interest. In some examples, after updating the destination location, the device may output directions to the destination location.

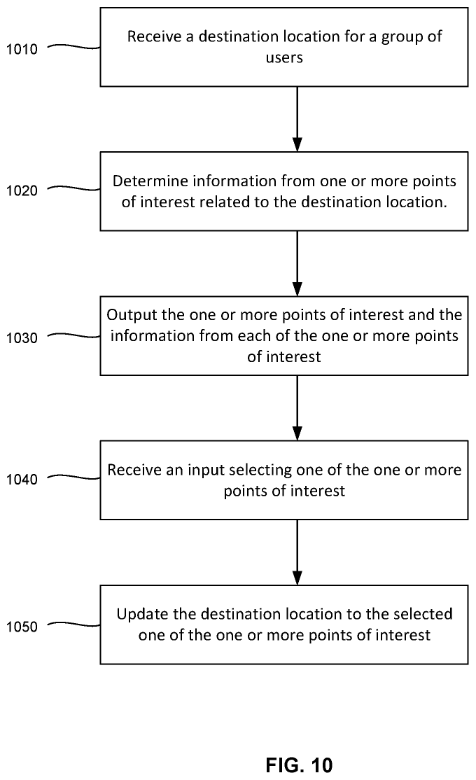

FIG. 10 illustrates another example method for updating the destination location for one or more users of the group of users. The following operations do not have to be performed in the precise order described below. Rather, various operations can be handled in a different order or simultaneously, and operations may be added or omitted.

In block 1010, the system may receive a destination location for a group of users. For example, an event invite may be created using an event application or an application associated with an event application server. The event invite may include the destination location. In some examples, the event invite may include one or more destination preferences. Based on the destination preferences, the event application may suggest or identify candidate destination locations. The system may receive an input corresponding to a selection of one of the suggested destination locations.

In block 1020, the system may determine information from one or more points of interest related to the destination location. For example, the system may identify, based on the received destination, a classification of the destination location. The classification of the destination location may be, for example, a gas station, a restaurant, a store type, a lodging type, a recreational facility, an entertainment location, or a park. According to some examples, the classification may have sub-classifications. For example, a restaurant may be sub-classified based on the type of cuisine, whether it is take-out or dine-in, formal or family style, etc. Determining information from the one or more points of interest may include determining that the points of interest have a same classification as the classification of the destination location.

According to some examples, the information may be, for example, a discount code, special offer, or a voucher. The information may be used to encourage or entice the users to change their destination to the point of interest associated with the information.

In block 1030, the system may output the one or more points of interest and the information from each of the one or more points of interest. For example, the system may output the points of interest and the corresponding information as a list, as points on a map, as a pop-up or overlay on the event invite, as a notification, etc. According to some examples, the output of the one or more points of interest and the corresponding information may be based on a determination of whether or not a user is in control of a vehicle. The system may output the points of interest and information different based on the determination. For example, if the system determines that the user in in control of the vehicle, the system may output the points of interest and information audibly. In some examples, if the system determines that the user is in control of the vehicle, at least a portion of the information may not be output visually. According to some examples, if the system determines that the user is not in control of the vehicle, the points of interest or information may be output visually.

In block 1040, the system may receive an input selecting one of the one or more points of interest. For example, the system may receive an input corresponding to a selection of the information from one of the points of interest.

In block 1050, the system may update the destination location to the selected point of interest. In some examples, after updating the destination location, the system may output directions to the destination location.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements. The use of “or” throughout should not be interpreted as limiting the subject matter to one or the other. Rather, the user of “or” should be understood as meaning the first, the second, the nth, or any combination of the listed features.

1. A method, comprising:
receiving, by one or more processors, a destination location for a group of users;
determining, by the one or more processors, information from one or more points of interest related to the destination location;
outputting, by the one or more processors, the one or more points of interest and the information from the one or more points of interest;
receiving, by the one or more processors, an input selection corresponding to one of the one or more points of interest; and
updating, by the one or more processors, the destination location to the selected one of the one or more points of interest.

2. The method of claim 1, wherein determining information from the one or more points of interest further includes identifying, by the one or more processors based on the destination location, a classification of the destination location.

3. The method of claim 2, further comprising determining, by the one or more processors based on the identified classification, information from the one or more points of interest having a same classification as the classification of the destination location.

4. The method of claim 3, wherein the classification of the destination location includes at least one of a gas station, a restaurant, a store type, a lodging type, a recreational facility, an entertainment venue, or a public space.

5. The method of claim 1, wherein the information from the one or more points of interest includes dynamic offer information based on the destination location.

6. The method of claim 1, wherein the information from the one or more points of interest includes a discount code, a special offer, or a voucher.

7. The method of claim 1, wherein receiving the input selection corresponding to the one of the one or more points of interest includes receiving, by the one or more processors, the input from at least one user of the group of users.

8. The method of claim 1, further comprising outputting, by the one or more processors, directions to the updated destination location.

9. The method of claim 1, further comprising determining, by the one or more processors, whether a user of the group of users is controlling a vehicle.

10. The method of claim 1, wherein outputting the information for the one or more points of interest is based on determining whether the user is controlling the vehicle.

11. The method of claim 10, wherein outputting the information from the one or more points of interest further comprises outputting, by the one or more processors based on determining that at least one user is controlling a vehicle and at least one user is not controlling a vehicle, the information differently.

12. The method of claim 10, wherein outputting the information for the one or more points of interests comprises outputting, by the one or more processors based determining that the user is controlling the vehicle, the information audibly.

13. The method of claim 10, wherein at least a portion of the information is not output visually to users determined to be controlling the vehicle.

14. The method of claim 10, wherein outputting the information for the one or more points of interests comprises outputting, by the one or more processors based determining that the user is not controlling the vehicle, the information visually.

15. The method of claim 1, wherein outputting the information from the one or more points of interest occurs before a user of the group of users begins traveling to the destination location or after the user of the group of users begins traveling to the destination location.

16. A device, comprising:
one or more processors, the one or more processors configured to:
receive an input corresponding to a destination location for a group of users;
receive information from one or more points of interest related to the destination location;
display the one or more points of interest and the information from the one or more points of interest;
receive an input selecting one of the one or more points of interest; and
update the destination location to the selected one of the one or more points of interest.

17. The device of claim 16, wherein receiving information from the one or more points of interest further includes identifying, by the one or more processors based on the destination location, a classification of the destination location.

18. The device of claim 17, wherein the one or more processors are further configured to determine, based on the identified classification, information from the one or more points of interest having a same classification as the classification of the destination location.

19. The device of claim 16, wherein the one or more processors are further configured to determine whether a user of the group of users is controlling a vehicle.

20. A non-transitory computer-readable medium storing instructions, which when executed by one or more processors, cause the one or more processors to:
receive an input corresponding to a destination location for a group of users;
receive information from one or more points of interest related to the destination location.
display the one or more points of interest and the information from the one or more points of interest;
receive an input selecting one of the one or more points of interest; and
update the destination location to the selected one of the one or more points of interest.

21-29. (canceled)
